(19) United States
(12) Patent Application Publication
(10) Pub. No.: US 2021/0047156 A1
(43) Pub. Date: Feb. 18, 2021

(54) ADVANCED SOFT LOOP CONNECTION SYSTEM FOR A BLOCK

(71) Applicant: Donald Butler Curchod, Avalon Nsw (AU)

(72) Inventor: Donald Butler Curchod, Avalon Nsw (AU)

(21) Appl. No.: 16/994,031

(22) Filed: Aug. 14, 2020

Related U.S. Application Data
(60) Provisional application No. 62/888,090, filed on Aug. 16, 2019.

(51) Int. Cl. B66D 1/36

(52) U.S. Cl. CPC B66D 1/36; B66D 2700/026

(57) ABSTRACT

A block with soft loop connection system comprising an attachment to the block of two soft loops such that at least a first soft loop end is able to be passed through one or more load bearing members and then back around a shoulder attached to at least a first side of the block. The soft loops' lengths causing the block to be self-aligning.

### CROSS-REFERENCE TO RELATED APPLICATIONS

Pursuant to 35 U.S.C. 119(e), this application hereby claims the benefit of the earlier filing date of Provisional U.S. Patent Application 62/888,090 filed on Aug. 16, 2019, the content of which is incorporated by reference herein in entirety.

### TECHNICAL FIELD

Subject matter disclosed herein relates to a block using a soft loop connection system to connect the block to a load point.

### BACKGROUND

Typically, blocks employing soft loop connection system are not self-aligning and can easily become misaligned with the result that the blocks generate substantial side loads and forces. This leads to increased friction, excessive overload forces on the bearing edges and excessive forces on the block sides all resulting in poor performance and damage to the block. Even a slight misalignment can causes excessive load to be applied to the edges of the bearing, whereas it is desirable to distribute the load evenly over the bearing surface to avoid severe degradation in the load bearing capacity and damage to the bearing.

Another disadvantage of state of the art soft loop connection blocks is that the axis of the load point must be perpendicular to the axis of the sheave, which limits their utility. Further, if applied to a snatch block, when the block is opened, it can be lost overboard (e.g., in marine applications) since there is nothing to secure the block to the vessel once the block is opened.

### SUMMARY

A new and improved soft loop connection system is disclosed herein that includes a reliable self-aligning block, resulting in negligible side loads necessary for good performance and reduced failures in the bearing and sides of the block.

Also, one of the new proposed systems herein allows 2 connection axes for correct alignment, 90 degrees apart.

Thirdly, the system proposed herein, when applied to a marine Snatch Block, when one loop is disengaged to open the block, as second loop is still connected to the load point of the boat, the proposed system having two separate loop connections.

### BRIEF DESCRIPTION OF THE DRAWINGS

FIG. 1 shows an elevation of a block and soft loop connection system according to one or more embodiments.

FIG. 1A shows an alternative loop construction FIG. 1B show another alternative loop construction.

FIG. 1B shows another alternate loop construction.

FIG. 1C shows another alternate loop construction.

FIG. 2A shows an end elevation of an alternative block and soft loop connection system according to the present invention.

FIG. 2B shows an end elevation of an alternative block and a soft loop connection system according to the present invention.

FIG. 2C shows an end elevation of a current block and soft loop connection system with typical misalignment according to the present invention.

FIG. 2D shows a modification to loop of FIG. 2C.

FIG. 2E shows an end elevation of an alternative block with a soft loop connection system according to the present invention.

FIG. 3A shows an end elevation of an alternative block with a soft loop connection system according to the present invention.

FIG. 3B shows an end elevation of an alternative block and soft loop connection according to the present invention.

FIG. 3C shows an end elevation of an alternative block and soft loop connection system according to the present invention.

FIG. 3D shows a side elevation of an alternative block and soft loop connection system according to the present invention.

FIG. 4 shows a view of an alternative block and soft loop connection system according to the present invention.

FIG. 5 shows a view of an alternative block and soft loop connection system according to the present invention.

FIG. 5A shows a detail of knot of FIG. 5.

FIG. 5B shows a detail of an alternative loop end.

FIG. 6 shows a view of a detail of a loop connection according to the present invention.

FIG. 6A shows an alternative soft loop connection system according to the present invention as applied to FIG. 8.

FIG. 7 shows a view of an alternative loop connection to that of FIG. 8.

FIG. 8 shows a view of an alternative loop connection to that of FIG. 7.

FIG. 8A shows a view of another alternative loop connection.

FIG. 8B shows a view of an alternative loop connection to that of the preceding figures.

FIG. 8C shows an end view of FIG. 8B.

FIG. 9 shows a view of an alternative block with another type of loop connection.

FIG. 10 shows a view of an alternative block with another type of loop connection.

FIG. 11 shows a view of two alternative block with a further type of loop connection.

### DETAILED DESCRIPTION OF EXAMPLE EMBODIMENTS

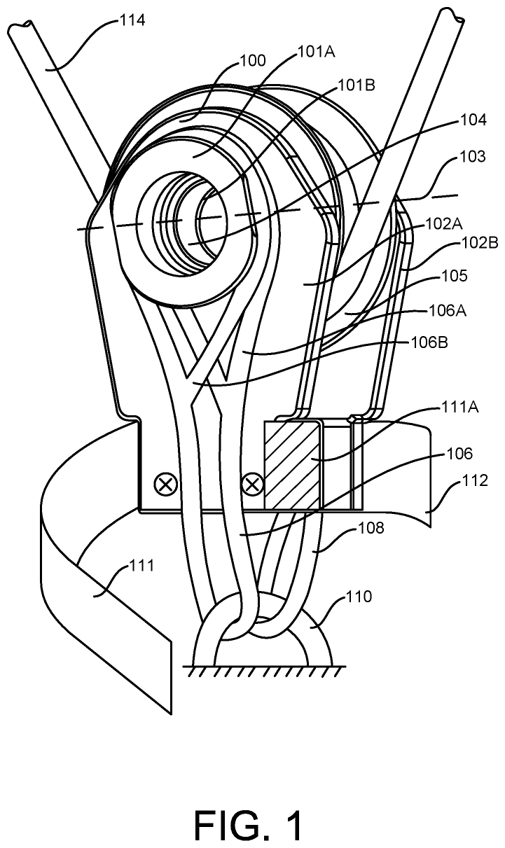

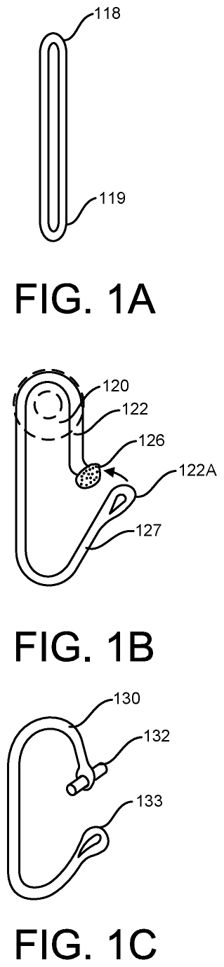

The accompanying drawings, which are incorporated in and constitute a part of this specification, show certain aspects of the subject matter disclosed herein and, together with the description, help explain some of the principles associated with the disclosed implementations as provided below. FIG. 1 shows a typical soft loop block 100 with grooved collar 101A on first front side and second similar grooved collar 101B mostly hidden on opposite back side at 102B. Block 100 has front side 102A and back side 102B respectively. A central sheave is shown at 105. The centerline of shaft 104 is shown at 103.

A first soft loop end 106A is shown looped around collar 101A soft loop end loop 106B is shown looped around a load point 110 and back along front side 102A and over grooved collar 101A so as to provide a first connection to load point 110. Note that block is symmetrical around sheave 105.

A second soft loop 108 is shown also looped around load point 110 travelling along back side 102B with each end of loop 108 [being similar to loop 106] fitted around back side collar 101B, hidden. A hook and loop wrap is shown at 112 which when wrapped around block 100, secures loops 106 and 108. Please note that any common method of restraint to secure loops 106 and 108 may be employed, such as slots, snap on covers or lacing. In one embodiment, if loops 106 and 108 are similar in length below block 100 when a load is applied, then the center of the sheave will be aligned with plane of the loading rope 114 and the load point 110.

In accordance with some aspects, the disclosed block will be correctly aligned under load, with no significant side forces generated which could otherwise cause damage to block. Although a single line with a loop at each end is shown for simplicity, in the majority of examples herein, a loop similar to that of FIG. 1A, with loop end 118 fitting over collar 101A of FIG. 1 and loop end 119 passing through a load point and back up over collar 101A could also be used on each side of block. Especially in a snatch block, a portion of hook and loop could be used at 111A which when hook or loop 111 is partially wrapped around to engage only hook or loop portion 111A, the backside loop 108 will be free while frontside loop 106 will be secured, so preventing the block from separating from the load point 110 (and being lost overboard in marine applications).

FIG. 1B shows yet another possible loop 122. Loop 122 is connected to Block side or collar 101A of FIG. 1, shown at 120 and is joined by means of a knot or button 126 around which loop end 122A passes so as to connect block to a load point at 127. Notably, loops as described at 106, 108, 118 and elsewhere in this application are usually, but not necessarily, constructed of multiple fibers.

FIG. 1C shows another rope loop 130 having a pin 132 around which loop end 133 passes in order to form a loop which can replace loop 106 of FIG. 1. Note that this loop of FIG. 1C or FIG. 1B, can replace a loop in any of the following Figures.

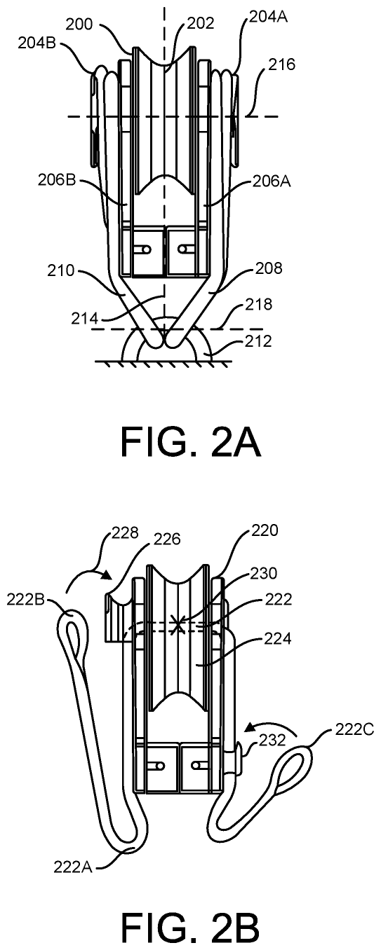

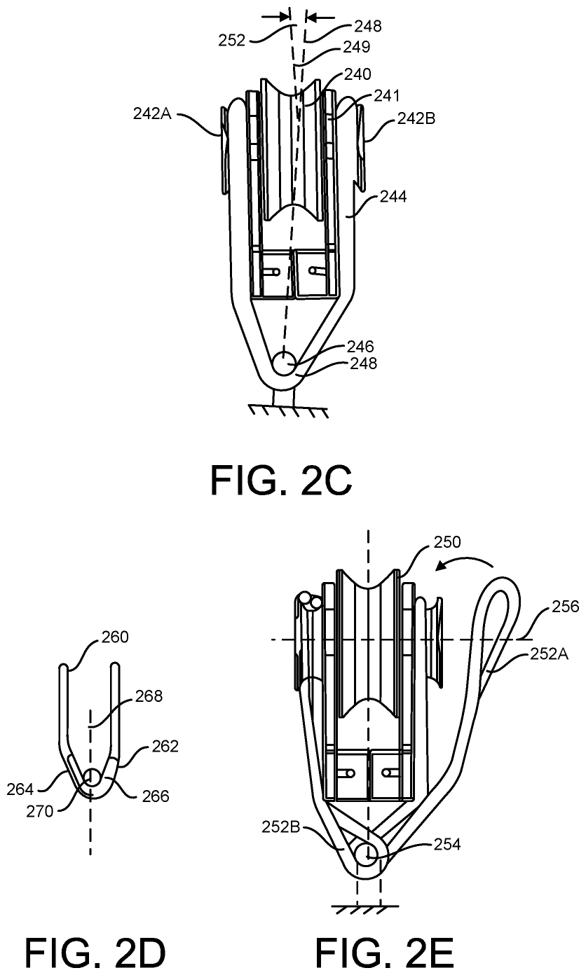

FIGS. 2A-2E show a block with various configurations of loops.

FIG. 2A shows a block 200, being similar to block 100 of FIG. 1, with sheave 202, grooved collars 204A and 204B and side 206A and 206B. A loop 208 is shown looped around collar 204A and load point 212, on the right-hand side. A similar loop 210 is shown on the opposite, left-hand side, looped around collar 204B and also around load point 212. Note that loops on each side pass around load point and back up each side and over a shoulder.

Hence if loops 208 and 210 when loaded with a rope around sheave are of similar length below block 200 then block 200 center line 202 is aligned correctly with the load point centerline 214, so as to avoid damage due to misalignment. It should be noted in this configuration, axis of sheave 216 is parallel to axis of load point 212 shown by 218.

FIG. 2B shows a block 220 similar to that of FIG. 2A, except that loop 222 with loop ends 222A and 222B pass through center of shaft shown dotted at 222. On the left-hand side of block 220 is the top of a collar 226 which is attached to shaft [hidden] of sheave 224. Loop 222 passes through center of shaft 224 and down left-hand side of block 220 so that it can be passed through a load point [not shown] and back over shoulder of collar 226 shown by arrow 228. If a similar construction and loop arrangement is constructed on the right-hand side of block 220 and loops are of similar length below block when loaded, then block will be aligned, and no substantial side forces will be generated.

Note for this to occur loop 222 must be held tightly within shaft 224, indicated by X 230. On the right-hand side of block 220 is shown an alternate arrangement to that of the right-hand side, in that no collar is present. In its place, is a post and shoulder 232 fastened to lower portion of block side 220. Loop 222 runs down right-hand side of block 220 and can be passed through a load point and over shoulder of pin 232. If a similar construction and loop is present on the left-hand side of block 220 then when loaded, no substantial side forces will be present in block.

FIG. 2C shows a current soft loop block 240 with collars 242A and 242B upon which loop 244 is attached, by passing loop 244 from one side of block to the other through load point 246. Soft loop 244 is shown attached to load point 246. Typically such current blocks do not have any inherent alignment. The loop 244 being soft, can load in any position, shown typically at 248. In such a position, when block is loaded, center line of load 248 is misaligned and remains misaligned with block center line 249, thus causing damaging side loads.

FIG. 2D shows loop 260 of FIG. 2C with the addition of a V tube on the right side at 262 and a partial V tube on left side at 264. Note tube may be of rigid semi rigid material. Tube or partial tubes would be secured on soft loop 26 either as shown laced in position at 264 and 266 or with adhesive or pressure or any other normal securing means.

If V tube or partial V tube center is set to align with centerline 268 of the soft loop 260, then even if loop 260 is off center when block is loaded, when a load is applied, tube or semi tube will cause loop to slide so that look comes to rest in the v bottom as shown at 270 so that block loop 260 and load member 270 are correctly centrally aligned so as to prevent the damaging side loads shown in FIG. 2C. FIG. 2E shows a block similar to that of FIG. 2A but in which loops pass around load point 254 such that load point 254 is perpendicular to sheave axis 256.

If loops are similar in length below block when a load is applied, then the center of the sheave will be aligned with plane of the loading rope and the load point. In this way, such a block, unlike current soft loop blocks, will be correctly aligned under load, with no significant side forces generated which could otherwise cause damage to block.

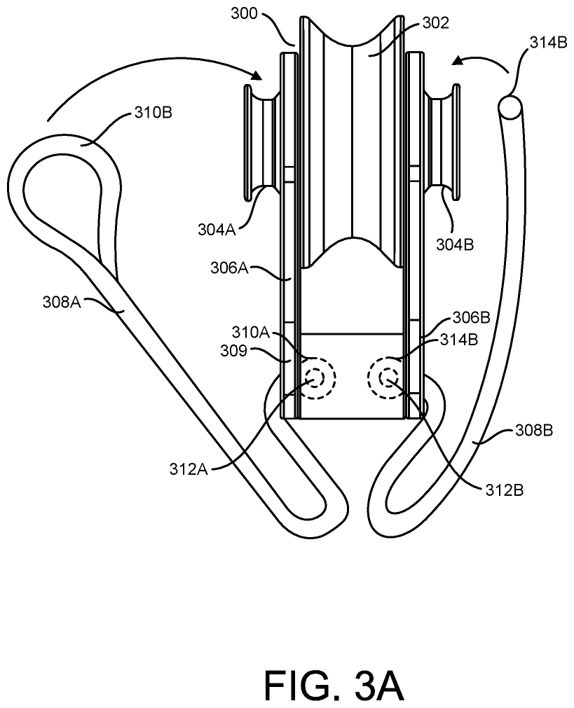

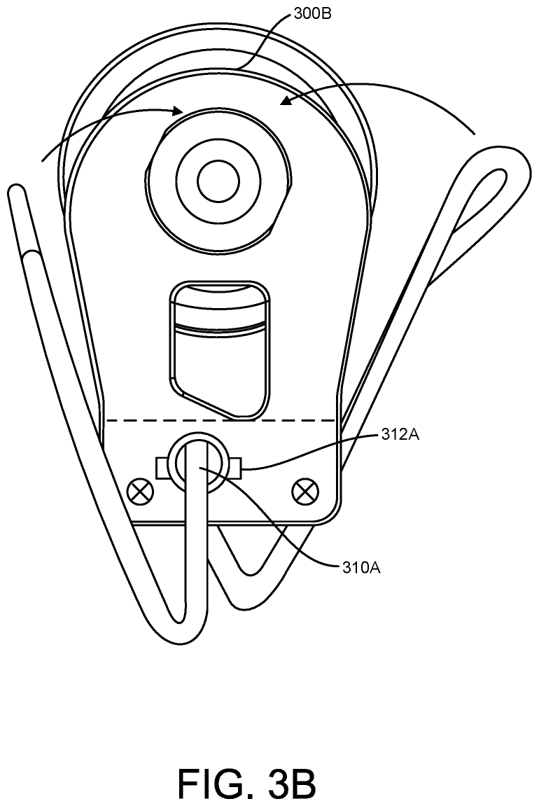

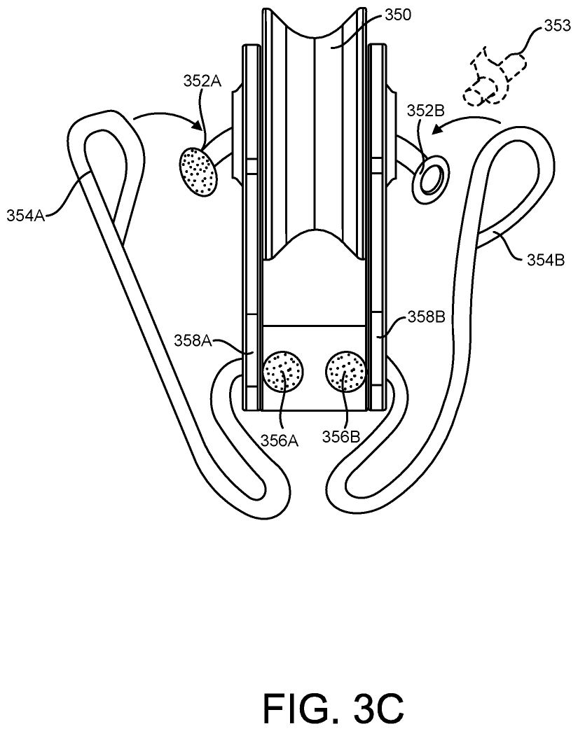

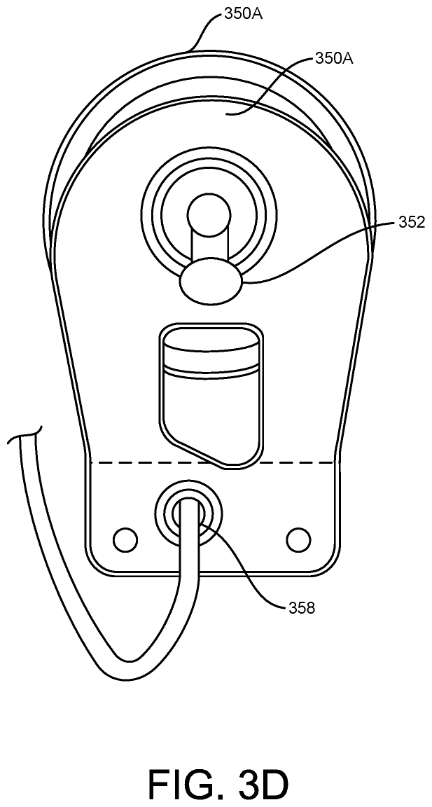

FIG. 3A shows the end view of a block 300, similar to previous blocks, but with an alternative loop connection. Block 300 has sheave 302, side collars 304A and 304B with sides 306A and 306B. A loop is attached to each side shown by 308A and 308B. Loops 308A and 308B are connected to holes in sides, one shown at 309. Loop 308A has a loop on each end, 310A and 310B, while loop 308B has also end loops 314A and 314B. loop ends are secured in sides by pins 312A and 312B. Block 300 is attached by passing Loop ends 310B and 314B through a load point [not shown] and back over each side on to groove shoulders 304A and 304B respectively.

In this way, If loops are similar in length below block when a load is applied, then the center of the sheave will be aligned with plane of the loading rope and the load point. In this way, such a block, unlike current soft loop blocks, will be correctly aligned under load, with no significant side forces generated which could otherwise cause damage to block.

FIG. 3B shows block 300B being a side view of block 300 of FIG. 3A, with a side view of loop end 310A secured by pin 312A.

FIG. 3C is an end view of a block 350, similar to block 300 except side collars are replaced by knots 352A and 352B so that loop ends 354A and 354B can loop over knots 352A and 352B respectively. Ends opposite to ends 354A and 354B pass through holes in sides 358A and 358B and are secured by knots 356A and 356B. Notably, knots could be replaced by other common terminations such as a button and knot or a button, loop end and pin. In this way, loop ends 354A and 354B can pass through a load point [not shown] and back each side over knots 352A and 352B. If loops are similar in length below block when a load is applied, then the center of the sheave will be aligned with plane of the loading rope and the load point. Such a block, unlike current soft loop blocks, will be correctly aligned under load, with no significant side forces generated which could otherwise cause damage to block.

FIG. 3D is block 350A, being a partial side view of block 350 of FIG. 3C, showing loop ends 352 and side hole 358

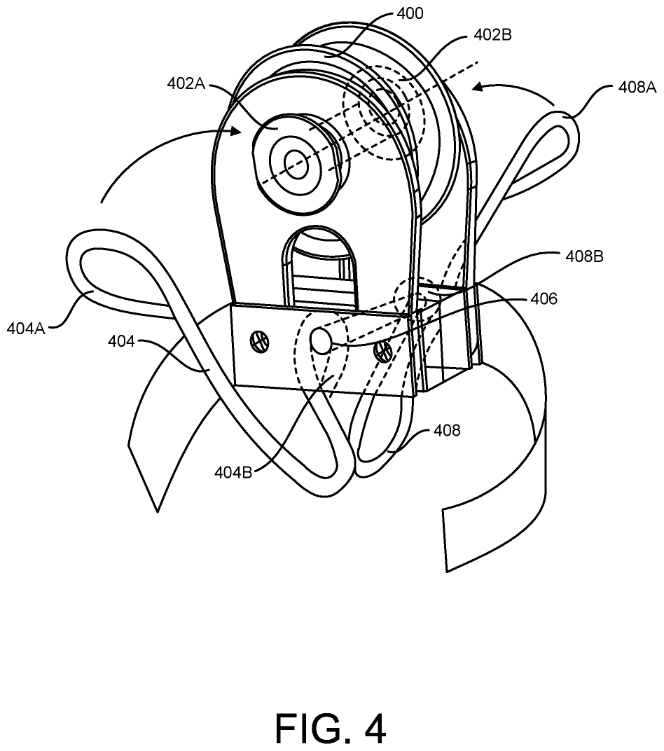

FIG. 4 shows a block 400 with side collars on each side, one at 402A and one hidden at 402B. Each side has loops 404 and 408 have loop ends 404A, 404B, 408A and 408B. Loop ends 404B and 408B are secured by a single pin 406, (or two separate pins) Loop ends 404A and 408A are each designed to pass through a load point and back over shoulders 402A and hidden shoulder 402B. If loops are similar in length below block when a load is applied, then the center of the sheave will be aligned with plane of the loading rope and the load point. Such a block, unlike current soft loop blocks, will be correctly aligned under load, with no significant side forces generated which could otherwise cause damage to block.

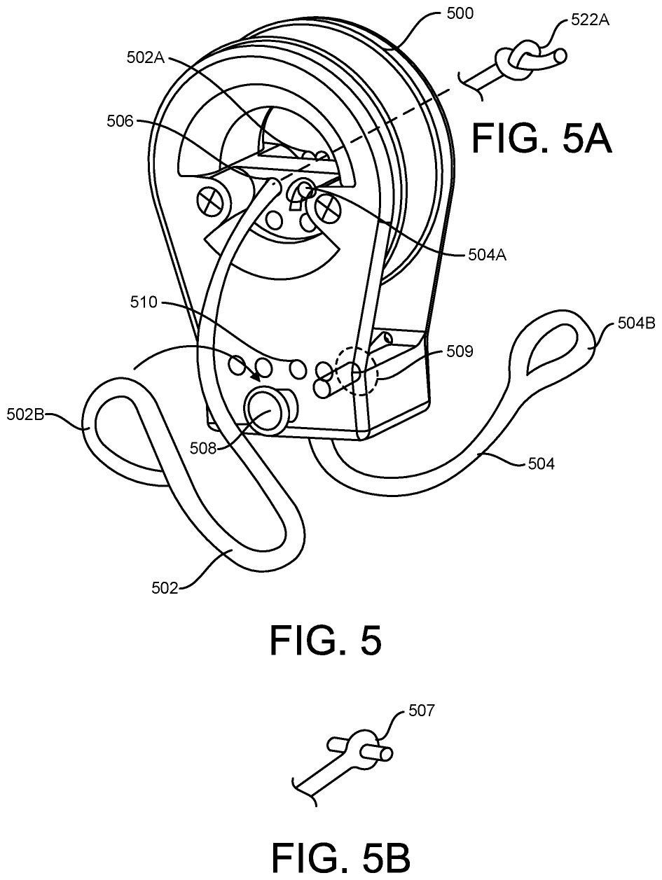

FIG. 5 shows a block 500 with two loops 502 and 504. Loop 502 has one end passing through block at 506 and secured by knot shown at 502A (partially hidden) other end of loop 502 has an end loop 502B. Loop 504 on back side of block 500 has end loop 504B. loop 504 has opposite end passing through block and knotted at 504A.

The bottom of block 500 has a post 508 with a similar post 509 on back side of block.

Loops 502 and 504 are designed to pass through a load point [not shown] and over shoulders of pins 508 and 509 on their respective side so as to form a separate connection to the load point on each side. Note that loops could pass through holes at 510 instead of holes at 506. If loops 502 and 504 are of equal length below block 500 when loaded, then a self-aligning connection is obtained so that no damaging side forces will be present in the block.

FIG. 5A shows full knot 522A of knot 502A of FIG. 5.

FIG. 5B shows a loop end and pin 507 which could replace knot 502 of FIG. 5.

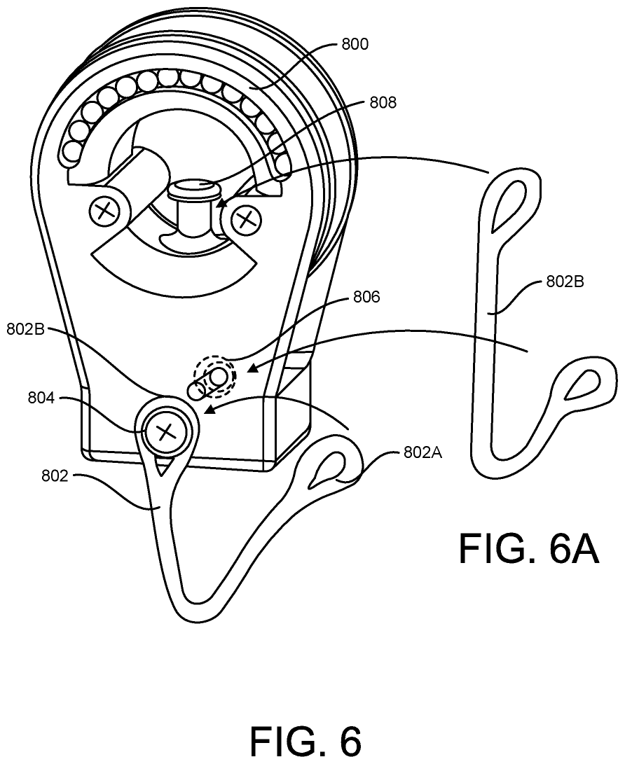

FIG. 6 shows a block 800 with loop on both sides one only being shown at 802, having loop ends 802A and 802B. At bottom of block is a pair of posts, one being shown at 804, the other hidden behind block 806. Loop end 802A is designed to pass through a load point [not shown] and back over post 804. Note post 804 is designed to hold both loop ends 802A and 802B.

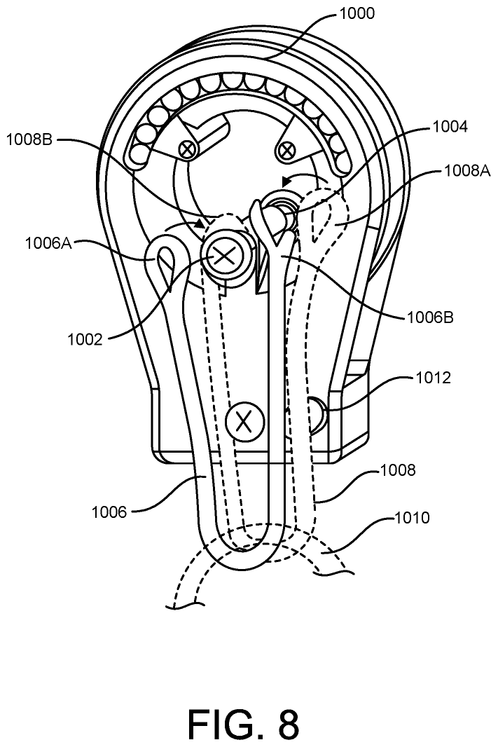

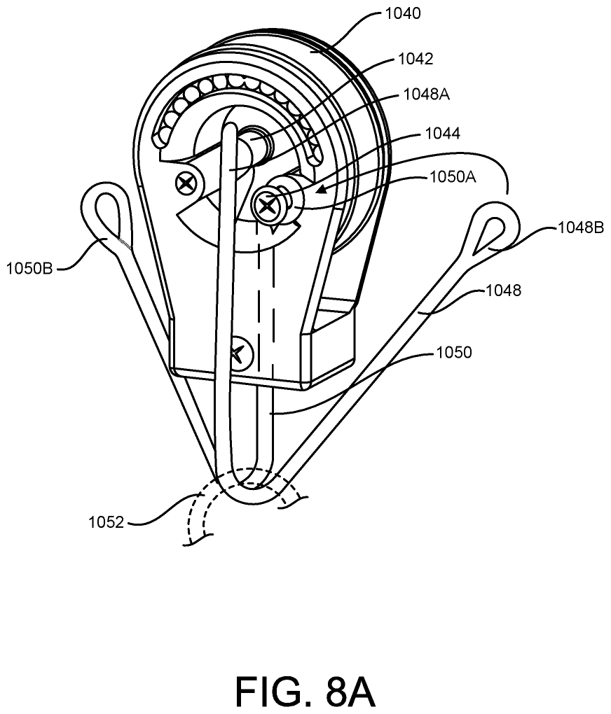

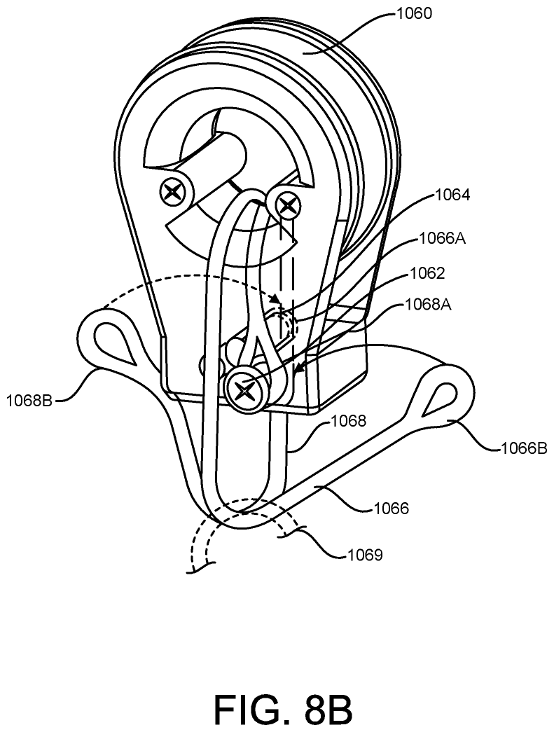

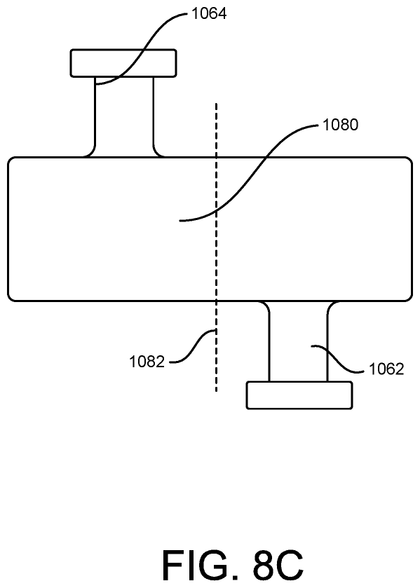

FIG. 6A shows an alternative loop 802B to that of loop 802. The top loop end of loop 802B is designed to fit over post 808 of FIG. 8 while bottom loop end of loop 802B is designed to fit over post 806 of FIG. 8. Note a loop is required to fit on each side of block 800, but only one is shown for simplicity. If a loop similar to loop 802 or 802B is used on both sides and is of equal length below block, then when block is attached to a load point, block will be aligned and the center of the sheave will be aligned with plane of the loading rope and the load point. In this way, such a block, unlike current soft loop blocks, will be correctly aligned under load, with no significant side forces generated which could otherwise cause damage to block.

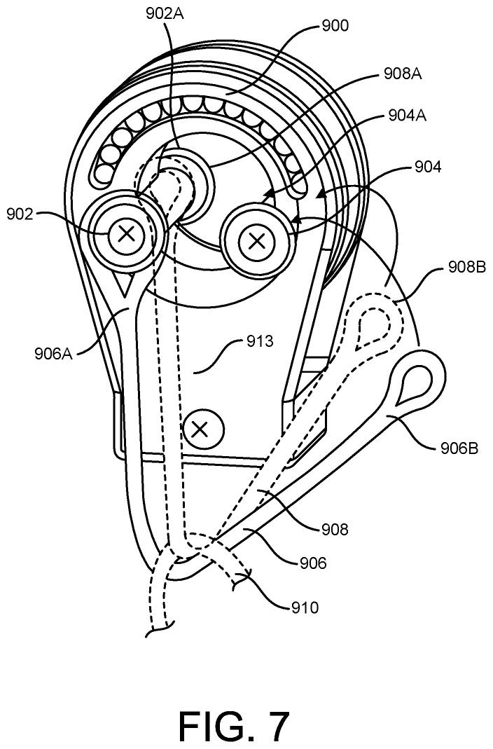

FIG. 7 shows a block 900 with posts 902, 902A, 904 and 904A spaced on each side of block. Loop 906 is shown on front side of block 900 with loop ends 906A and 906B. loop 908 is shown on back side of block with loop ends 908A and 908B. Loop end 906A is designed to fit over post 902. Loop end 906B is designed to pass through load point 910 and back over post 904 on front side of block 900. Loop end 908A is designed to fit over post 902A with loop end 908B passing through load point 910 and back over post 904A. Hence, if loop ends below block are of similar length then when loaded, correct alignment is maintained so that any substantial damaging side forces are avoided.

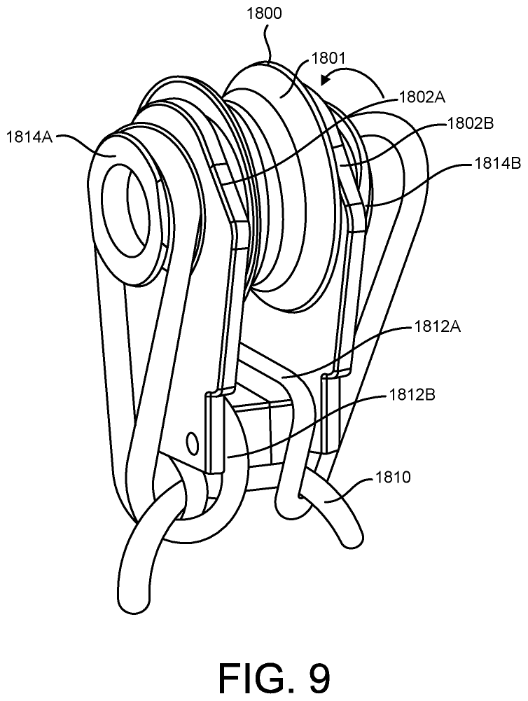

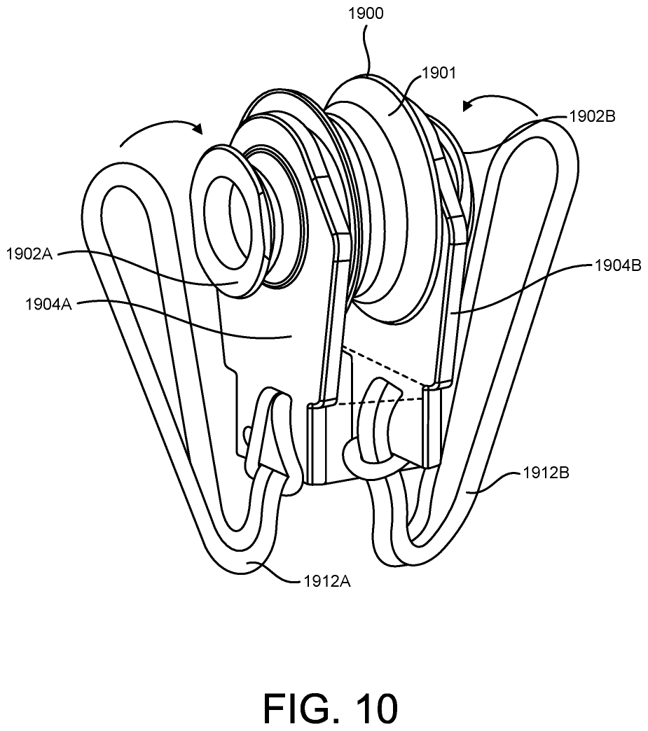

FIG. 8 shows a block 1000 similar to that of FIGS. 8, and 9 except there is one post on each side of block 1000 marked 1002 on the front side and 1004 on the back side. Block 1000 has two soft loop connections, 1006 on the front side and 1008, shown shaded, on the back side. Each loop has a loop end, marked 1006A, 1006B, 1008A and 1008B. Loop 1006B fits over back side pin 1004. Loop 1006 then passes through block, down front side of block 1000 through load point 1010 and back along front of block, and then loop end 1006A fitted over pin 1002, so forming a first connection to load point 1010.

Loop end 1008B fits over front side pin 1002. Loop 1008 passes through center of block, then down back side, through load point 1010 and back up back side and over pin 1004, forming a second connection to load point 1010. In some aspects, if loops below block are of equal length under load, such a block, unlike current soft loop blocks, will be correctly aligned under load, with no significant side forces generated which could otherwise cause damage to block.

FIG. 8A shows block 1040 with two centrally located posts, one at 1042 on the back side and post 1044 on the front side. Block 1040 has loops 1048 and 1050 respectively.

Loop 1048 has loop end 1048A fitted to post 1042. Loop end 1048B passes through block center and down front side of block 1040 through load point 1052 and back over front side post 1044. Loop end 1050A fits over front post 1044 through block center and down back side then through load point 1052 and over back post 1042. If the lengths of the two loops 1006 and 1008 below the block are equal, then when loaded, block is perfectly aligned with the load, and no damaging side forces are generated. In this way, such a block, unlike current soft loop blocks, will be correctly aligned under load, with no significant side forces generated which could otherwise cause damage to block.

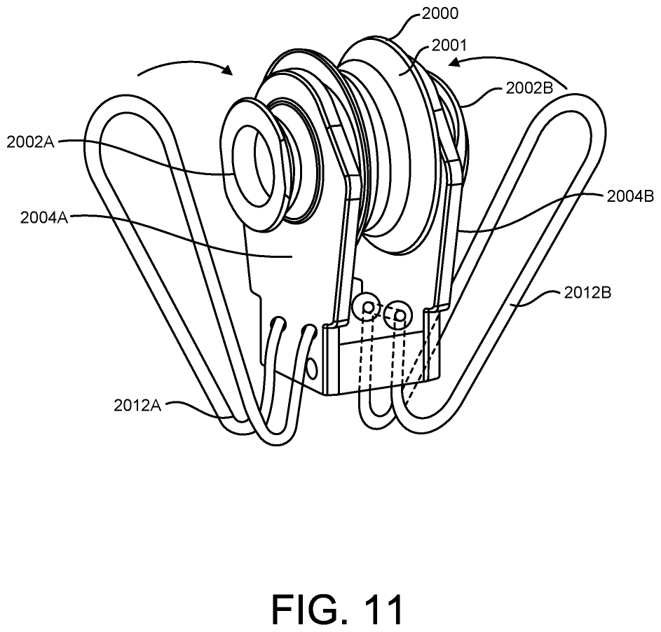

FIG. 8B shows a block 1060, similar to the previous blocks with one post on each side, 1062 on the front side and 1064 on the back side respectively, at the bottom of the block. Block 1060 has two loops 1066 and 1068. Loop 1066 has loop end 1066A attached to rear post 1064 loop end 1066B passes through block 1060 down front side, through load point 1069 and back over front post 1062. Loop end 1068A fits over front post 1062 through block 1060 center down back side through load point 1069 and back over post 1062. In this way, such a block, unlike current soft loop blocks, will be correctly aligned under load, with no significant side forces generated which could otherwise cause damage to block. FIG. 8C is a bottom view 1080 of FIG. 10B showing posts 1062 and 1064 equally spaced about centerline 1082.

FIG. 9 shows a block 1800 with a sheave 1801 and sides 1802A and 1802B. Soft loops 1812A and 1812B are shown looped around the bottom of sides 1802A and B. End of loop 1812A passes through load member 1810 then back alongside 1802A and over shoulder 1814A. End of loop 1812B similarly passes through load member 1810 then back alongside 1802B and over shoulder 1814B. In one aspect, if the load loop ends are of the correct length, in this case roughly equal, then when a load is applied to the sheave 1801, the block becomes self aligning since it will automatically align with the load so that damaging side forces are avoided.

FIG. 10 shows a typical block 1900 having another method of attaching a loop to a block. Block 1900 has a sheave 1901 and sides 1904A and 1904B. Soft loops 1912A and 1912B are shown terminated by looping around a slot in the lower portion of sides 1904A and B. Free end of loop 1912A can pass through a load member similar to that of FIG. 9, then back alongside 1904A and over shoulder 1902A. End of loop 1912B similarly can passes through a load member similar to 1910 of FIG. 9, then back along side 1904B and over shoulder 1902B. In one aspect, if the load loop ends are of the correct length, in this case roughly equal, then when a block is connected to a load member, and a load is applied to the sheave 1901, the block becomes self aligning since it will automatically align with the load so that damaging side forces are avoided.

FIG. 11 shows a typical block 2000 having yet two other methods of terminating a soft loop to a block. Block 2000 has a sheave 2001 and sides 2004A and 2004B. Ends of loop 2012A pass through side 2004A, and held by heads, hidden, but similar to that of FIG. 3A or 3C. Ends of loop 2012B pass through bottom of side 2004B as shown and are terminated by loop ends and one or more pins shown at 2014, similar to that of FIGS. 3b and 3D. Note that one head of loop 2012A can be inside side 2004A while one head can be outside side 2004A shown by dotted loop part 2006.

Free ends of loops 2012A and 2012B can then passes through a load member, not shown, then back along sides 2002A and 2002B respectively, and over respective shoulders 2002A and 2002B. If loops ends are of the correct length, so that when loaded the bottom ends of loops are approximately of equal length below the block, then when the block is connected to a load member and a load is applied to the sheave 2001, the block becomes self aligning since it will automatically align with the load so that damaging side forces are avoided. In some embodiments, the self-aligning soft loop connection features above can be applied to any type of block, fixed, Snatch, plain bearing, ball or roller bearing. The preceding examples are not meant to limit the construction of a block in any way.

Although only a hook and loop wrap to constrain loops is shown in FIG. 1, any commonly used form of restraint, i.e., a snap on piece, a built in slot etc. my be used. Any method of construction shown or loop connection in one figure may be combined with any other method or construction shown in another figure, in order to achieve a self-aligning block according to the disclosed material. Any type of loop or method of terminating loop end or ends to a block can also be used. In the above, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others. A portion of the disclosure of this patent document may contain material, which is subject to copyright protection. The owner has no objection to facsimile reproduction by any one of the patent documents or the patent disclosure, as it appears in the Patent and Trademark Office patent files or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

What is claimed is:

1. A block with soft loop connection system comprising an attachment to the block of two soft loops such that at least a first soft loop end is able to be passed through one or more load bearing members and then back around a shoulder attached to at least a first side of the block.

2. The block of claim 1, wherein when a load is applied between a sheave of the block and at least one load member, at least the first soft loop end on a first side of the block is of a first length.

3. The block of claim 2, wherein the first length is sufficiently long to cause the load to be roughly aligned with the sheave center plane which is perpendicular to an axis of the sheave such that excessive side loads on the block causing damage are prevented.

4. The block of claim 3, wherein when the load is applied between the sheave of the block and a first load member and a second load member, the first soft loop end on the first side of the block is of the first length and a second soft loop end on the second side of the block is of a second length.

5. The block of claim 4, wherein the first length and the second length are sufficiently long to cause the load to be roughly aligned with the sheave center plane which is perpendicular to an axis of the sheave such that excessive side loads on the block causing damage are prevented.

6. The block of claim 1, wherein a rigid or semi rigid V tube attached to the soft loop, such that the V of the V tube is retained on the soft loop so that when loaded the V causes the soft loop to center on a load restraint so that damaging side loads are prevented.

7. The method of claim 1, wherein a second soft loop end is able to be passed through the one or more load bearing members and then back around the shoulder attached to a second side of the block.

8. The block of claim 1, wherein a first the two soft loop ends is able to be passed through the one or more load bearing members and then back around the shoulder attached to the first side, and a second of the two soft loop ends is able to be passed through the one or more load bearing members and then back around the shoulder attached to a second side of the block.

9. The block of claim 8, wherein at least one of the first or the second soft loop ends is directly attached to a side of the block.

10. The block of claim 8, wherein both of the first and the second soft loop ends are directly attached to the first and second sides of the block, respectively.
